(19) United States
(12) Patent Application Publication
(10) Pub. No.: US 2004/0034796 A1
(43) Pub. Date: Feb. 19, 2004

(54) Copy- protection system and method

(76) Inventor: James R Clark, Aurora, CO (US)

Correspondence Address: Ken J Pendersen, Pedersen & Company, PO Box 2666, Boise, ID, 83701-2666, US

(21) Appl. No.: 10/415,501

(22) PCT Filed: Oct. 27, 2001
(86) PCT No.: PCT/US01/50768

(51) Int. Cl. H04L 9/00; H04K 1/00

(52) U.S. Cl. 713/201; 705/57; 380/201; 713/189

(57) ABSTRACT

The present invention provides copyright protection to media services operating across the Intranet. Copyright protection customers are first registered with the media services' copyrighted data provider, and then provided access to the media services' database, including music and audiovisual material, via the Internet to a single playing device with a unique identifier. Preferably, access is provided via a scrambled digital file containing the unique identifier and data blocks from the database. By using the invented format and systems, secure access and secure downloading of copyrighted contents are done while maintaining copyright protection.

### BACKGROUND OF THE INVENTION

### FIELD OF THE INVENTION

Embodiments of the present invention relate to digitally encoded copyrighted data of any kind. As an introduction to the problems solved by the present invention, consider the development of present-day MP3.WAV type players. MP3 technology allows users to download audio and music content over the Internet for play on MP3 compatible playing devices, including those that are portable and those internal to a personal computer. From the point of view of the audio and music content recording industry, a major drawback to the presently available MP3 devices and technologies is that they afford virtually no protection against copyright infringements by either Internet MP3.WAV sourcing parties, nor by MP3 end users. The present invention remedies this functional deficiency by a novel and innovative process for controlling access to media content through a copy-protection format that allows the copyrighted information to be played or displayed only on a targeted media player device and only for a predetermined number of plays. This system would protect any type of digitally encoded data that was transmitted on the Internet or via other digital transmission medium.

### SUMMARY OF THE INVENTION

The present invention relates to on-line servers and databases operated by a media service providing operation across the Internet or an Intranet. These services would be available to customers who have playing devices with unique identifiers that would allow the server to identify the unique customer and cross reference them to a customer database. Then the serviced product would be put into the novel copy-protected format (“m2m format”) with the unique identifier for the target device embedded in the format so that it would play only on the intended target device.

For example, customers for a music file would give the player-code number for their player to the provider of music which would convert the audio file to the m2m format which would only de-code on the target player. Transferred files are not transportable and are dedicated to the particular target device. Any attempt to copy the transferred file from one device to another would not be useful. The transferred files may only be played on the particular target device. With the m2m copy-protection format the provider of the file would be able to determine which device the file would play on and how many times it could be played.

The benefits of the novel format are made possible by the incorporation of a unique serial number for each target device. This could be a MAC code on a network card or a serial number in an E-Prom for the target device. The unique serial number must be identifiable by the vendor of copy-protected material and unique to the target media player device. Once the m2m format player software is installed on the target device, the transferred files may be displayed or displayed by the user.

Once the user is registered, the then-operational target device can be used to access the provider servers, which give access to copyrighted content libraries, on a per title basis. For marketing promotions, pre-selected portions of titles could be made available for free review (by prior arrangements with copyrighted content providers). Once titles are selected for downloading, charges are made to the customer's account. Each account is billed to the pre-arranged credit card on a monthly or other basis.

With this type of format and control of data information, providers (e.g., music companies) could justify lower fees for downloading(i.e., as little as 25 cents per title) due to the low cost of conveying the song to the customer and control of number of plays. This low cost will be seen as a valuable feature by the end user. At the same time, copyright rights are protected and the artists and recording companies can collect negotiated fees on a per title basis.

These and other embodiments, aspects, advantages, and features of the present invention will be set forth in part in the description, and in part will come to those skilled in the art by reference to the following description of the invention and referenced drawing, or by practice of the invention.

### BRIEF DESCRIPTION OF THE DRAWINGS

FIG. 1 is a schematic block diagram illustrating a routine that enables access to the inter-networked system components according to one m2m embodiment of the invention.

### DETAILED DESCRIPTION OF THE INVENTION

The present invention provides a system and method for providing copy-protected digital information from vendor databases to users in a manner that completely protects the copyright rights of the vendor. The system utilizes a globally unique identifier, which is unique to a particular playing device. The system encrypts the copy-protected digital information such that it may only be de-encrypted on said particular device with said unique identifier. The information may only be played or displayed on the particular device identified by the vendor. Furthermore, the information may only be played or displayed on the particular device a set number of times. The vendor sets the number of times the information may be played or displayed.

The idea is to rewrite and scramble digital files where all bits of information in the file are spread and shifted so that any part of this file is not readable by any means. For example, this is not true for MP3 files since they are “periodic” codes, where some pattern is again and again repeated and helps synchronize a data stream. Thus, if you cut MP3 files into short sequences, it could be played separately in these pieces. Further MP3 coding has no protection against replay and may be copied onto and played by other devices (e.g., PC, MP3-player, etc.). MP3 utilizes universal coding, which may be used for any use on any MP3 device. Notably, the novel m2m format is private and enables the song to be played only by the registered user, on the particular uniquely identified device, in specifically defined order, and for a specified number of times.

M2M format uses the following:

a) Preamble: which consists of the M2M file identifier, M2M version number and Player identifier;

b) Public Key: Users numeric name or Identification Number;

c) Private Key: The key that unlocks the data on the destination player. This key is held separately and is not part of the file transfer, but is on the target device;

d) Play Counter: which says to the player how many times this song may be played including the option of unlimited plays;

e) Encoding and Encryption type description: This would be an integer number which specifies method of scrambling;

f) File size description: Description of size of blocks and number of blocks in file and number of M2M data blocks; and

g) M2M Data blocks: The data block is then packed by a scrambling algorithm with a predetermined digital file signature based on the public key of the target destination player.

Sample file structure:

Structure of M2M file:

| Offset [B] | | Length [B] | Description |
|---|---|---|---|
| 0 | 0 × 00 | 4 | M2M file identifier: “.M2M” |
| 4 | 0 × 04 | 4 | Version - version of M2M |
| 8 | 0 × 08 | 4 | Player Identifier |
| 12 | 0 × 0C | 4 | Play Counter |
| 16 | 0 × 10 | 4 | Number of blocks |
| 20 | 0 × 14 | | M2M data blocks |
| — | | 4 | 32 bit CRC of whole file |

Structure of each M2M data block:

| Offset [B] | | Length [B] | Description |
|---|---|---|---|
| 0 | 0 × 00 | | Encoding type for |
| | | | this block |
| 4 | 0 × 04 | 4 | Length of data in |
| | | | bytes (usually 1024) |
| 4 | 0 × 08 | | Data |
| — | | 4 | 32 bit CRC of block |

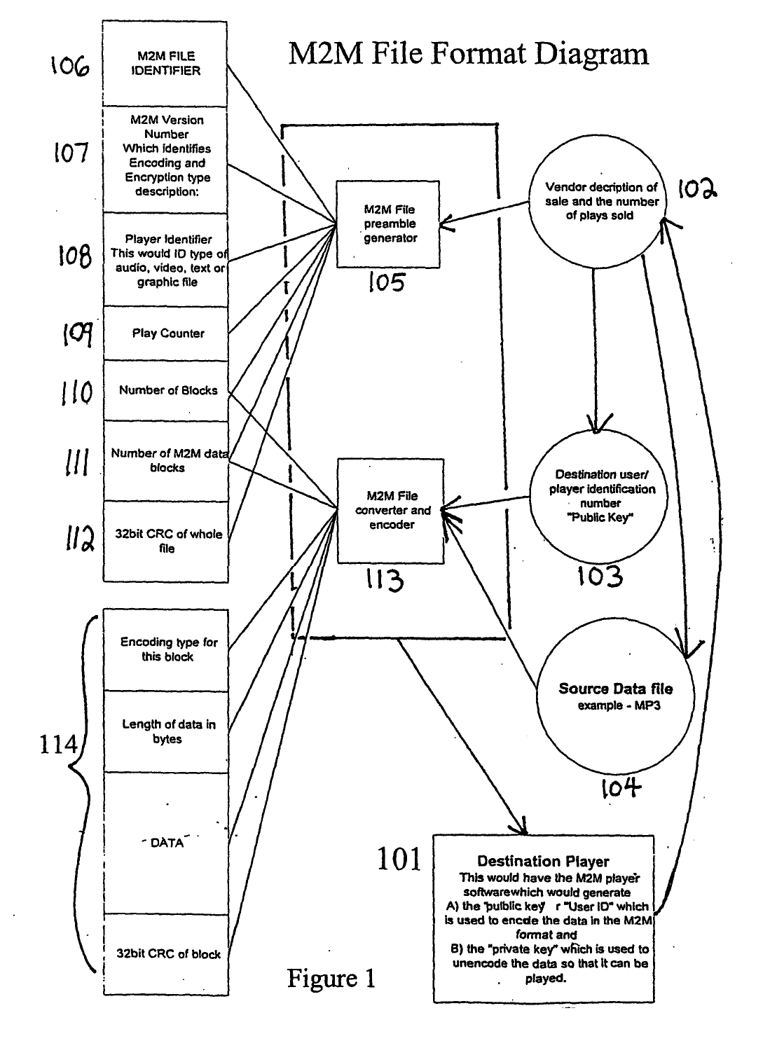

One embodiment of the present invention may be better understood by reference to FIG. 1. FIG. 1 is a schematic diagram illustrating a routine that enables access to the inter-networked system components according to one m2m format embodiment of the invention. The customer accesses the vendor 102 via the destination media player 101. The destination media player 101 is equipped with the m2m player software which would generate both 1) the “public key” (or “user ID”) which is used to encode the data in the m2m format; and 2) the “private key” which is used to unencode the data so that it can be played or displayed. The public key is unique to each particular destination player. The public key information is transmitted to the vendor 102 from the destination player 101. The private key information is never transferred.

The user interacts with the vendor 102 in making purchasing decisions. The user chooses the information to be accessed and the number of times said accessed information may be displayed or played. For example, the user may choose a particular MP3 file to be played on the destination player 101, and may also choose the number of times (including an unlimited number of times) that the file is to be played.

The first time a user accesses the vendor 102 with a particular player 101, billing information may be obtained. The unique serial number associated the particular destination player 101 may be used as a user ID for billing purposes. Future selections may be charged to the user's account according to the pre-arranged billing information.

Once the vendor 102 has identified the destination player's 101 unique public key, and the user has made all selections, the vendor 102 provides the information to the novel copy protection system 115.

The vendor 102 provides the novel system 115 with information including: the destination player public key information 103, the source data file 104 selected by the user, the type of file (e.g., MPEG, JPEG, MP3, DVD, etc.) chosen by the user to be transmitted to, and displayed on, the destination player 101, the size of the chosen file, the number of plays chosen by the user (interpreted by the play counter 109) and the version of the encoder/unencoder on the user's destination player 101 (identified by an m2m version number 107 which identifies encryption type).

The m2m file preamble generator 105 includes: the m2m file identifier 106; the m2m version number 107 (which identifies encoding and encryption type); the player identifier 108 (which identifies the type of file requested); the play counter 109 (which determines the number of plays requested); the number of blocks 110, the number of m2m data blocks 111, and the 32 bit CRC of the entire file 112.

The m2m file converter and encoder 113 uses the public key information 103 provided by the vendor 102 to convert the source data file 104 into the novel encrypted format.

Each m2m data block 114 contains an encrypted portion of the source data file 104. The data file is rewritten and scrambled such that all bits of information are spread and shifted rendering any part of the converted file unreadable. Only after the entire file is transferred from the novel system 113 to the destination player 101 may the data be unencrypted and decoded via the private key on the destination player 101. Only the specific destination player 101 with the particular public key, which was provided to the vendor 102, may unencrypt the file. No other device is so enabled. While the file may be downloaded onto other devices (e.g., the user's PC), it may only be unencrypted and played or displayed on the particular destination player 101 containing the public key provided to the vendor 102.

Although this invention has been described above with reference to particular means, materials and embodiments, it is to be understood that the invention is not limited to these disclosed particulars, but extends instead to all equivalents within the scope of the following claims.

I claim:

1. A system for copy-protected transmission of digitally-encoded data across the Internet, comprising:
an on-line server and database operated by a media service;
an Internet playing device with a unique identifier operated by a customer, said playing device being operatively coupled to said server and database as a result of permission granted by said media service due to recognition of said unique identifier; and
a scrambled digital file containing the unique identifier and data blocks from said database.

2. The system of claim 1, wherein the database contains music material.

3. The system of claim 1, wherein the database contains audio-visual material.

4. The system of claim 1, wherein the scrambled digital file has a public key which is the unique identifier.

5. The system of claim 1, wherein the playing device has a private key which is not part of the scrambled digital file.

6. The system of claim 1, wherein the scrambled digital file has information that limits the number of times the file may be played by the playing device.

7. A system for copy-protected transmission of digitally-encoded data across an intranet, comprising:
an on-line server and database operated by a media service;
an intranet playing device with a unique identifier operated by a customer, said playing device being operatively coupled to said server and database as a result of permission granted by said media service due to recognition of said unique identifier; and
a scrambled digital file containing the unique identifier and data blocks from said database.

8. The system of claim 7, wherein the database contains music material.

9. The system of claim 7, wherein the database contains audio-visual material.

10. The system of claim 7, wherein the scrambled digital file has a public key which is the unique identifier.

11. The system of claim 7, wherein the playing device has a private key which is not part of the scrambled digital file.

12. A method for providing copyright-protected information across the Internet or an intranet, the method comprising:
providing an on-line server and database containing copyrighted information;
operatively coupling said server and database with a playing device containing a unique identifier upon recognition of said identifier by said server and database; and
transmitting a scrambled digital file containing said unique identifier and copyrighted information to said playing device.
